(19) United States
(12) Patent Application Publication
(10) Pub. No.: US 2003/0160674 A1
(43) Pub. Date: Aug. 28, 2003

(54) Rotor, rotating machine and magnetic field generating apparatus

(76) Inventors: Matahiro Komuro, Hitachi (JP); Masashi Kitamura, Mito (JP); Motoya Itou, Hitachinaka (JP); Yoshihiko Kuriyama, Kumagaya (JP)

Correspondence Address: DICKSTEIN SHAPIRO MORIN & OSHINSKY LLP, 2101 L Street NW, Washington, DC, 20037-1526, US

(21) Appl. No.: 10/372,342

(22) Filed: Feb. 25, 2003

(30) Foreign Application Priority Data
Feb. 27, 2002 (JP) 2002-051761

(51) Int. Cl. H01F 7/02

(52) U.S. Cl. 335/302

(57) ABSTRACT

The present invention provides a ring magnet made of hard magnetic material having a ring shape, which has an orientation ratio of 50% by volume or more of easy magnetization axis in the radial direction at the pole center position. The present invention also provides a method of manufacturing a ring magnet comprising a step of orientating magnetic powder of hard magnetic material, which comprises molding the magnetic powder filled in a ring shaped mold under a pressure in an axial direction of the ring, and applying magnetic field to the ring shaped mold with a magnetic field generating means disposed to the periphery of the mold.

### FIELD OF THE INVENTION

The present invention relates to a ring magnet for use in a surface magnet motor wherein a magnet is disposed on the periphery of a rotor, a method of manufacturing the same, a rotor using the ring magnet, a rotating machine, a magnetic field generating apparatus and a ring magnet manufacturing apparatus.

### DESCRIPTION OF PRIOR ART

A ring magnet of an anisotropic magnet wherein magnetization direction changes along a circumferential direction is disclosed in Japanese Patent Laid-open 2000-269062 and 2000-195714. In these prior publications, there is disclosed a method of making a polar anisotropic magnet having high magnetic characteristics, which comprises oriented magnetic powder. However, the prior publications do not disclose how to orientate magnetic powder. Orientation of magnetic powder in a sine wave magnetic field cannot lower cogging torque.

### BRIEF DESCRIPTION OF DRAWINGS

FIG. 1 is a sectional view of a magnetic field generating apparatus according to the present invention.

FIGS. 2(a), (b) are sectional views showing the orientation of magnetic powder of the ring magnet according to the present invention.

FIG. 3 is a graph showing dependency of the orientation angle on field strength of a 10 poles ring magnet shown in FIG. 1.

FIG. 4 shows dependency of orientation angel on the thickness (depth) of the 10 poles ring magnet.

FIG. 5 is a graph showing dependency of the orientation angle on field strength of the 10 poles ring magnet.

FIG. 6 is a graph showing dependency of the orientation angle on field strength of the 4 poles ring magnet.

FIG. 7 is a graph showing the relationship between cogging torque and orientation angle.

FIG. 8 is a graph showing the relationship between surface magnetic flux density wave strain and field strength of orientation.

FIG. 9 is a perspective view of a rotor according to the present invention.

FIG. 10 is a sectional view of a rotating machine.

### DESCRIPTION OF THE INVENTION

In a conventional ring magnet, it was difficult to lower the cogging torque and to manufacture the ring magnet in a mass production scale. Especially, mere orientation in a sine wave magnetic field for orientation of magnetic powder is hard to make the cogging torque with respect to a motor torque less than 1%. The above prior publications do not disclose concrete methods of orientation of magnetic powder.

Complete sine wave for orientation is improper for mass production of the magnets. It is almost impossible to arrange the powder in 100% same direction without any distribution fluctuation of orientation angles. Reasons for this phenomenon are as follows: shape and powder size are different; it is difficult to make complete sine wave; movement of particles in powder in a pressing step take place; Shrinkage of sintered body; Quality of magnetization field; and so on.

In practice, even if the magnet characteristics are not 100% sine wave, such ring magnets have sufficiently practical use. There are technical problems to provide a ring magnet having sufficiently low cogging torque that is in a practical range, with a high efficiency.

An object of the present invention is provide a ring magnet, a method of manufacturing the same, a rotor using the magnet, a rotating machine, a magnetic field generating apparatus and a ring magnet manufacturing apparatus. The ring magnets of the present invention have high efficiency and high torque, and the object of the invention may be achieved by controlling more properly orientation of magnetic powder that constitutes the ring magnet.

The ring magnet of the present invention is featured that the magnet has an orientation ratio of easy magnetization axis in an amount not less than 50 volume % or more. Preferably, the orientation ratio should be 60% by volume or more, and most preferably 80% by volume or more.

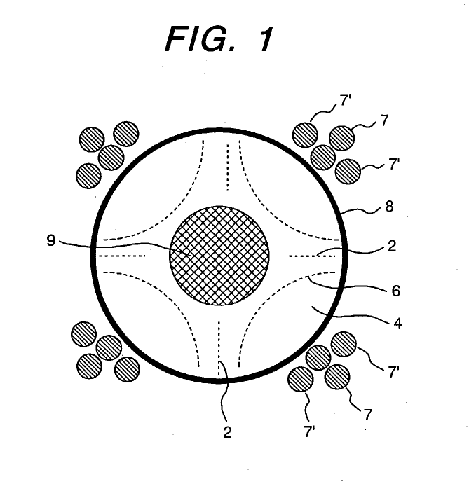

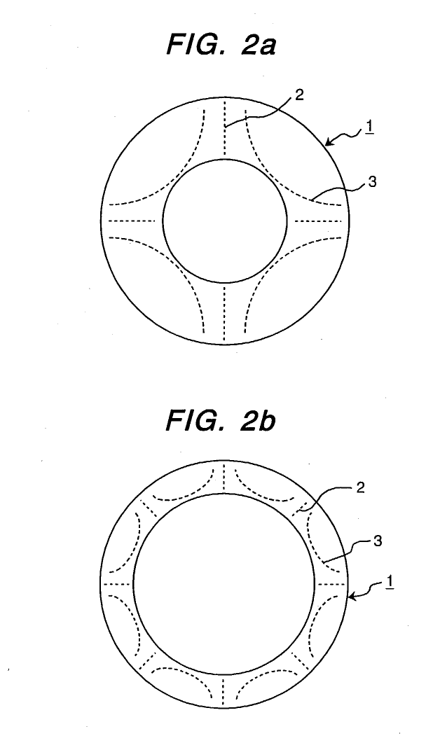

Further, the present invention relates to a ring magnet made of hard magnetic material, wherein the orientation ratio of easy magnetization axis formed in the radial direction at the center position between poles being 60% by volume or more, preferably 80% by volume or more, and most preferably 90% by volume or more. The center position between poles is herein after referred to as the pole center position. The position is shown in FIGS. 1, 2 by numeral 2.

Furthermore, the present invention relates to a ring magnet made of hard magnetic material, wherein orientation ratio of easy magnetization axis oriented in the perpendicular direction at the pole center position is 20% by volume or less, preferably 10% by volume or less, and most preferably 5% by volume or less.

The present invention is concerned with a ring magnet made of hard magnetic material, wherein the orientation ratio of easy magnetization axis formed in the radial direction at the pole center position being 60% by volume or more, preferably 80% by volume or more, and most preferably 90% by volume or more, and wherein a strain of sine wave in the outer periphery of the magnet is 10% or less, and preferably 5% or less.

The ring magnet according to the present invention has at least four magnetic poles; orientation ratio of easy magnetization axis at the pole center position is 50% by volume, and preferably 70% by volume; and a range of the orientation ratio mentioned above is within 5 degrees, preferably 1 to 4 degrees.

The present invention relates to a rotor having the above mentioned ring magnet disposed around a shaft barrel of the rotor, the magnet being bonded to the barrel with an adhesive or by metallurgical connection, wherein the cogging torque is 5% or less, preferably 2% or less, and most preferably 1% or less.

The present invention further relates to a rotating machine having a stator and the above mentioned rotor disposed in the stator. The rotating machine can preferably be used as a positioning motor.

The present invention provides a method of manufacturing a ring magnet comprising orientating powder of hard magnetic material arranged in a circular shape in a magnetic field, which comprises molding the powder filled in a ring shaped mold such as metal mold under pressure in the axial direction, and applying magnetic field to the powder with a plurality of magnetic field generating means disposed around the periphery of the ring metal mold at regular intervals, wherein the magnetic field generating means are controlled so that orientation ratio of easy magnetization axis at the pole center position (numeral 2 in FIGS. 1,2) is 50% by volume or more.

The present invention further provides a method of manufacturing a ring magnet from powder of hard magnetic material by orientating the powder in a magnetic field, which comprises a step of molding the powder filled in a ring shaped mold under pressure in a direction of the axis of the ring, and a step of applying magnetic field with a plurality of magnetic field generating means disposed around the periphery of the mold, wherein a first group of the magnetic field generating means (7 in FIG. 1) are arranged at regular intervals in accord with the number of poles of the means, and wherein a second group of the magnetic field generating means (7′ in FIG. 1) are aligned with respect to the both ends of the radial direction of the ring at the pole center position.

Further, the present invention provides a method of manufacturing a ring magnet from powder of hard magnetic material by orientating the powder in a magnetic field, which comprises a step of molding the powder filled in a ring shaped mold under pressure in a direction of the axis of the ring mold, and a step of applying magnetic field with a plurality of magnetic field generating means disposed around the periphery of the mold, wherein a first group of the magnetic field generating means are arranged at regular intervals in accord with the number of poles of the means, and wherein a second group of the magnetic field generating means are aligned with respect to the both ends of the radial direction of the ring magnet at the pole center position, the magnetic strength of the magnetic field in the radial direction being controlled to be larger than that of the both sides.

In the method of manufacturing a ring magnet according to the present invention, it is preferable that each of the magnetic field generating means having 4 poles or more generates a magnetic field in a direction opposite to that generated by an adjoining one, and generates a magnetic field in the same direction as that generated by a magnetic field generating means at an opposite position, that powder of hard magnetic material are pressure molded in its axial direction, followed by application of magnetic field by the means, and that alignment of the means is adjusted so as to control orientation ratio of easy magnetization axis being 50% by volume or more within a range of 5 degrees or less.

The present invention also provides a method of manufacturing a rotor having a shaft barrel around which a ring magnet is disposed, which comprises a step of making the ring magnet by the method mentioned hereinbefore, and forming an integrated body by bonding the ring magnet with an adhesive or by metallurgical connection to the barrel.

The present invention provides a magnetic field generating apparatus for generating magnetic field by a plurality of magnetic field generating means arranged around a periphery of a ring mold, wherein the magnetic field generating means are arranged at regular intervals, and also arranged with respect to radial direction of the ring magnet and both ends of the radial direction of the ring magnet.

The present invention also provides a magnetic field generating apparatus having magnetic field generating means arranged around a ring shaped mold, wherein a first group of the magnetic field generating means (7 in FIG. 1) are arranged at regular intervals in accord with the number of poles, a second group of the magnetic field generating means (7′ in FIG. 1) being provided at positions of the radial direction of the ring and both ends of the radial direction at the pole center position or at both ends of the first group of means, whereby a magnetic field strength in the radial direction is higher than that at the both ends.

In the above mentioned magnetic field generating apparatus, the magnetic field generating means are disposed in parallel with and throughout the whole length of the axis of the ring magnet, the number of the poles being 4 or more, the magnetic field generating means being aligned to generate magnetic fields in the same direction as that of opposite magnetic field generating means.

The present invention also provides an apparatus for manufacturing ring magnets wherein a magnetic field generating apparatus having a plurality of magnetic field generating means arranged around the periphery of the ring mold.

The method of manufacturing ring magnets of the present invention comprises preparing a powder composition having a desired particle size and containing NdFeB compound (A part or whole of Nd may be substituted with other rare earth metals such as Dy, a part or whole of Fe may be substituted with Co, and a part or whole of B may be substituted with other elements such as other semi metallic elements, the compound ma be doped with N, etc.), orientating easy magnetization axis of the composition in the magnetic field, pressure-molding the composition and sintering the molding. Then the molding is sintered to produce a ring magnet or arch magnet.

There are ring magnets whose specific directions of easy magnetization axis change in a sine wave form along the circumferential direction of the magnet. Such magnets have high magnetic flux density in their surfaces, and it is possible to make small leak flux at inner or outer peripheries of the magnets.

In manufacturing sintered bodies, magnetic powder is oriented after conditioning the particle size of the magnetic powder. If the direction of orientation or magnetic field strength is insufficient, orientation of the powder is-insufficient.

If the surface magnetic flux density changes in a sine wave form, cogging torque of a stator using such magnets will be small and induction voltage will become higher. One of the measures to increase efficiency of a rotating machine using a surface magnet type rotor is to make a sine wave form of magnetization direction. According to this method, higher harmonic wave is little and iron loss can be reduced.

In order to make magnetization direction of a sine wave form, it is important to use an anisotropic magnet whose magnetic powder is oriented in a specific direction, and to orient magnetic anisotropic magnet powder in a sine wave form.

The ring magnet should have a portion whose oriented direction is a sine wave form, when the magnet is rotated in a circumferential direction. An orientating yoke is designed to make the sine wave form orientation, thereby to optimize magnetic field strength and magnetic field direction.

The ring magnets that have designed by the concept above mentioned have the following features.

(1) Specific portions of crystals of powder are alternately oriented in a radial direction and in a direction perpendicular to the above direction to form at least two poles.

(2) Orientation degree of powder that has an oriented crystal in the same direction as the easy magnetization axis directed in the radial direction is slightly smaller than or almost equal to that of powder that has an oriented crystal in the same direction as the easy magnetization axis directed in the circumferential direction.

(3) The ratio (A2/A1) of the volume (A2) of magnetic powder whose crystalline direction is perpendicular to easy magnetization axis of 1/20 or less, based on the maximum volume (A1) of powder having crystalline direction in accord with easy magnetization axis at an angle (at the pole center position).

(4) The cogging torque of the rotor using the magnet is 1% or less.

(5) The X-ray diffraction strength of crystalline powder oriented in a direction in accord with easy magnetization axis along the radial direction is slightly lower or almost equal to that of crystalline powder oriented in accord with easy magnetization axis along the circumferential direction.

(6) An amount of wave component other than the basic wave of the surface magnetic flux density that is measured along the outer periphery of the ring magnet is 10% or less.

A surface magnet rotor employs, in general, an arch form or ring form magnet for the rotor. There are sintered magnets or bonded magnets as the rotor magnet. Since the sintered magnets have higher Br (residual flux density) and higher Hc (coercive force) than the bonded magnets, the sintered magnets are used when high induction voltage is required or a motor is used at a temperature higher than 100° C.

### DETAILED EXPLANATION OF PREFERRED EMBODIMENTS

A particle size distribution of sintered magnet powder material was adjusted to 3 to 10 micrometers, and then magnetic orientation treatment was conducted to orient the powder. The magnet is tetragonal crystal and easy magnetization axis is in c-axis.

FIG. 1 is a sectional view of arrangement of an orientating mold and coils for generating magnetic field. Coils 7,7′ are disposed at a magnetic material entrance 4. Magnetic field 5 is generated at the pole center position and magnetic field 6 is generated outside of the pole center position.

A sleeve made of heat resistant alloy, i.e. non-magnetic austenitic steel is disposed on the outer periphery of the magnetic material entrance 4. The center axis 9 is made of hard magnetic material or non-magnetic material; and in this example, heat resistant alloy was used as the center axis.

Dotted lines 2,6 show c-axis that is easy magnetization axis; at the pole center position, dotted lines 2 directed in radial directions are c-axis; and the dotted arches 6 outside of the pole center position show c-axis. Therefore, c-axis in the regions beneath the coils 7 is oriented in the circumferential direction, and c-axis in regions between coils 7 is oriented at a predetermined ratio in the radial direction so that the center between coils is formed. By adjusting the positions of the coils 7, 7′, the orientation ratio of c-axis in the radial direction in the pole center position can be increased remarkably.

Although FIG. 1 shows a 4 pole, such orientating yokes are employed in case of ring magnets of 3 poles or more. In FIG. 1, 4 coils are used for one pole, the number being decided by a value of orientating magnetic field of the magnetic powder. The powder should have at least 8000 Oe. If a higher magnetic field is needed, a diameter of coils 7, 7′ should be made larger so as to increase current flowing therethrough.

In FIG. 1, material entrance 4 has an inner diameter of 2 mm and outer diameter is 40 mm; a diameter of coil is 2.0 mm; and a thickness of the sleeve is 0.5 mm.

Four coils were arranged for one pole; 2 of the coils were disposed in radial direction at a position of the center between poles or at the pole center position, and other coils 7′ were disposed beside the above coils 7. The coils disposed beside the coils that are arranged in radial direction can be two or three. In this specification, coils 7 are a first group of magnetic field generating means, and coils 7′ are a second magnetic field means.

Magnetic material powder was filled in sleeve 8 and then was densely packed under vibration in the sleeve. Thereafter the powder was molded by a press machine under pressure of about 1 ton/cm² in axial direction and letting current flow in the coils to obtain a molding of a density of 70%.

The molding was taken out from the sleeve 8 of the mold, and then it was sintered at 1100° C. to obtain a sintered body of density of 90%. Then, the body was machined to obtain a ring magnet of a desired shape. In the resulting sintered body, magnetic powder remains as it is.

Orientation of c-axis of the powder in the radial direction at the pole center position can be increased to 80% by volume by this method even more 90% by volume or more. When only the coils 7 are disposed in the radial direction in the center between the poles, the orientation ratio of easy magnetization axis along the circumferential direction between the centers of the poles is 80% by volume or more, the field strength at the pole center position is small and the magnetic strength along the circumferential direction is not enough.

When the coils 7′ are disposed beside the center coils 7 as shown in FIG. 1, the magnetic field strength at the pole center position is sufficiently high. This arrangement of coils is applied to not only 4 poles shown in FIG. 1, but also to ring magnets having many poles such as 8 pole ring magnets or 10 poles ring magnets.

In this example, the orientation ratio of easy magnetization axis at the pole center position was 80% by volume or more, in the perpendicular direction with respect to the circumferential direction 20% by volume or less, and in the circumferential direction between the pole centers 90% by volume or more. The region where the orientation ratio is 80% by volume or more in the radial direction at the pole center position is within a range of 15 degrees.

The steps until sintering can be applied to a method of making bonding magnets. The bonding magnets are manufactured by heating a molded mixture of powder magnet material and resin to a temperature for softening the resin under the magnetic field, rather than under pressure for molding.

Orientation of magnetic powder after pressure molding in an orientating mold and after sintering can be investigated by an X-ray diffraction analysis.

This method is widely used, but a sample stage (goniometer) for the method for ring magnets was newly designed. In order to investigate a cylindrical sample, the goniometer is provided with an X, Y driving mechanism and a rotating mechanism.

An error of rotation angle was control to be less than 0.1 degree, and a width of the X-ray source (an impinging width of the X-ray optical system for evaluation of orientartion; the larger the width, the lower the resolution of the angles becomes.) was controlled to less than 1 degree, such that the X-ray can irradiate the curved surface of the ring magnet to evaluate orientation. Orientation of magnetic powder that constitutes the ring magnet can be investigated by this method. According to the number of poles, when orientation at the center between poles or in the sides of the pole is different, the diffraction strength depends on angles.

The outer and inner diameters of the magnetic powder entrance 4 shown in FIG. 1 are designed by taking into consideration shrinkage of the molding at the time of sintering and machining to remove strain of the product after orientation processing and sintering. That is, the size of the entrances 4 is larger than the size of the final product.

The position where current for applying magnetic field flows from the orientation yoke shown in FIG. 1 (areas other than those facing the coils 7, 7′) is important; the position of coils and an amount of current decide distribution of magnetic field strength and direction of magnetic field.

Based on the inner diameter and outer diameter of the ring and strength of magnetic field for orientating, the position of the coils 7, 7′ should be changed. When the coil location shown in FIG. 1 is chosen, a high orientation ratio even at the pole center position is realized so that high performance of the magnet and small strain of waveform in the surface magnetic flux density wave form can be expected.

In case of FIG. 1, there are coils 7 at the angle of the center between poles or the pole center position, and there are also coils 7′ on the both sides of the above coils 7. Magnetic strength in the center of poles and magnetic distribution can be made optimized by this arrangement of coils. For example, a distance of coils from the magnet, a diameter of coils, and a distance between coils 7 will change a vector of magnetic field at the position of the magnet; under these condition optimum designing should be conducted by simulation, etc.

The orientation yoke shown in FIG. 1 is used to adjust magnetic powder in the direction of magnetic field, but when the arrangement of the orientating yoke is improper, the evaluation of orientation of the magnets by X-ray of the resulting magnets is greatly different.

When optimized orientation yoke is designed with the optimized coil position, ring magnets can be manufactured with the orientation yoke, so that magnets exhibiting X-ray diffraction strength distribution shown in FIG. 4 are obtained.

FIG. 2 shows a sectional view of easy magnetization axis, i.e. c-axis of the ring magnet according to the present invention. The pole center between poles is defined as the pole center position where orientation direction (direction in accord with orientation direction of easy magnetization axis) at the center between poles changes in circumferential direction as shown in FIG. 2. The pole center distance is defined as a distance between the center of the poles and the next center of the poles.

The position between centers of poles is the position where dotted lines have the same direction as the circumferential direction (the same direction as easy magnetization axis). That is, the orientation directions between the center of poles and at the center of poles are perpendicular to each other with respect to radial direction or circumferential direction.

Although dotted lines in FIG. 2 are shown roughly, it is difficult to orient 100% of magnetic powder in the directions along the lines. The particle size of the powder is several microns. Since the shape of the powder particles is not uniform, and since the molding is pressed under pressure in a magnetic field, it is hard to orient all the magnetic powder particles that are contact with each other in the direction of magnetic field.

The easy magnetization axis of ring magnets obtained by the magnetic field generation apparatus is shown in FIG. 2. The ring magnet 1 in FIG. 2 has the orientation direction in the center 2 between poles and the direction other than that of the center 2. The dotted lines are diagrammatical ones, and normally magnets are magnetized in this direction. 4 Poles in (a) and 8 poles in (b) have the same orientation directions.

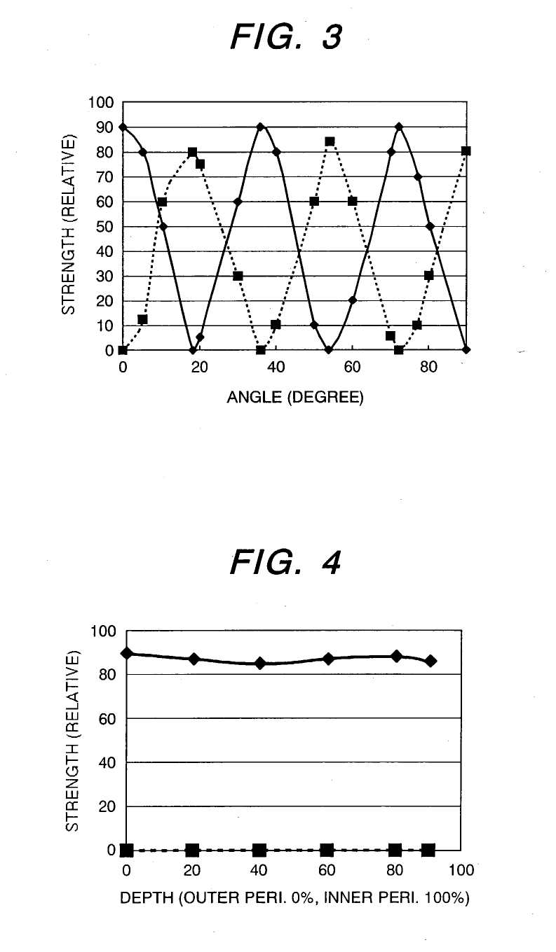

FIG. 3 shows a diagrammatic drawing of orientation of easy magnetization axis of a 10 poles ring magnet to which the coil arrangement shown in FIG. 1 was applied, the orientation in FIG. 3 being obtained after sintering and machining.

The solid line shows X-ray diffraction strength (relative value) in a plane perpendicular to c-axis, and dotted line shows X-ray diffraction strength (relative value) in a plane parallel with c-axis. Orientation of magnetic powder after orientation treatment in an orientation mold and sintering can be investigated by an X-ray diffraction analysis method. A detailed method is the same as mentioned hereinbefore.

The mid-center between poles is defined as the position where the center of an angle constituted by a center between poles and the next center between poles is located. The 10 poles magnet has change of orientation at every 36 degrees as shown in FIG. 3. The segments having high strength shown by solid lines represent that majority of magnetic powder is oriented in the radial direction of the ring magnet, and the segments having high strength shown by dotted lines represent that majority of magnetic powder are oriented in the circumferential direction of the ring magnet.

In FIG. 3, strengths at 0, 36, and 72 degrees shown by solid lines are high, but at the angles between the above angles strength is zero. This means that there are no magnetic powder of which c-axis is oriented in the circumferential direction at these center between poles.

Further, there are no magnetic powder of which c-axis is oriented in the circumferential direction in the mid-center between poles. It is apparent that the strength at the mid-center is higher than that at the pole center position. This means that oriented magnetic field is sufficient at the pole center positions. The strength shown by the vertical line in FIG. 3 represents the volume of magnetic powder. Therefore, the volume of magnetic powder oriented in the radial direction is larger than that of magnetic powder oriented in the circumferential direction.

There is shown in FIG. 4 an orientation distribution in the direction from the inner side to the outer side of the ring magnet evaluated as in FIG. 3. The orientation at the center (zero degree in FIG. 3) corresponds to that of the outer periphery, which is a value in FIG. 3. Thus, orientations in the inner and outer sides are the same.

The orientation yoke shown in FIG. 1 has a smaller magnetic strength in the inner circumferential side. Since the circumferential inner side satisfies orientation magnetic field and magnetic field direction (minimum magnetic field is 8000 Oe), there is almost no difference in orientation in the radial direction of the depth.

The ring magnet mentioned above is preferably used for motor rotors, because it has small cogging torque and high induction voltage.

The orientation can be investigated by structure analysis using an electron microscope, etc., other than X-ray diffraction analysis. Further, there are other methods for investigating orientation, such as hysteresis curve measurement or VSM (vibration sample magnetometer) by Kerr effect, magnetic structure observation by Kerr effect, refraction electron beam analysis, rutherford backscattering, etc.

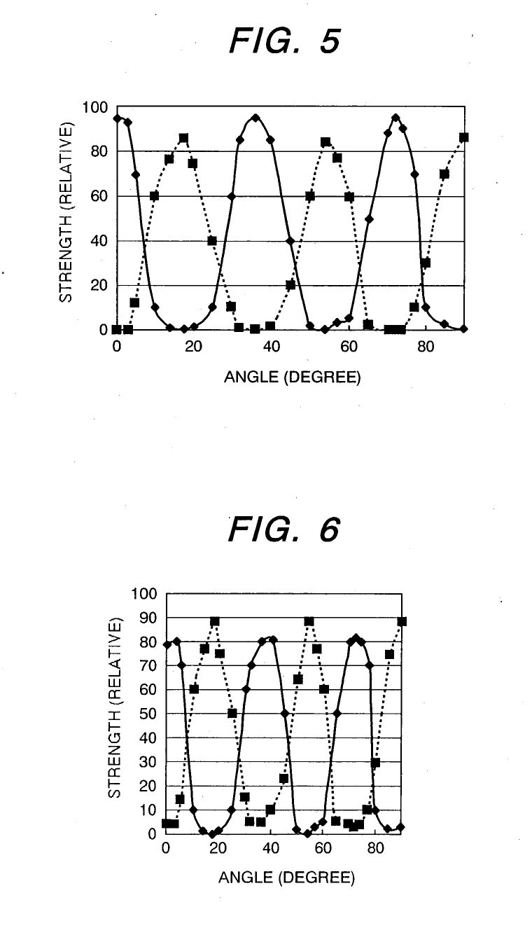

FIG. 5 shows magnetic field strength at the pole center position in a field strength of at least 10,000 Oe. Two coils at the pole center are supplied with large electric current. When a 10 poles ring magnet is manufactured under such the conditions, it has orientation shown in FIG. 5.

As is apparent from comparison of FIG. 5 with FIG. 3, the strength at the pole center position is higher than that of the magnet described by FIG. 3. It is seen that the range of zero strength regions in FIG. 5 is larger than that in FIG. 3.

When orientation at the center of the poles is the same or larger than that at the mid-center of poles, cogging torque becomes small, and the maximum value of the surface magnetic field density becomes maximum. This effect by coil arrangement is found not only in sintered type magnets, but also in bonding type magnets.

When NbFeB series compounds or SmFeN series compounds are injection-molded or pressure-molded, the above mentioned coil arrangement is employed so that the magnetic field in the pole center position is increased to achieve a low cogging torque magnet. This result is found in not only 10 poles magnet, but in all magnets of at least 3 poles.

FIG. 6 shows the case where the two coils at the center of poles were supplied with small current. This result represents magnetic field distribution of the case where there ire no coils at the both sides next to the coils at the pole center position. That is, the coils at sides are not dislocated in the circumferential direction. This case shows that strength of solid lines is higher than that of dotted lines. Further, the strength shown by dotted lines at the pole center position is not zero. This is because the magnetic strength at the pole center position is small.

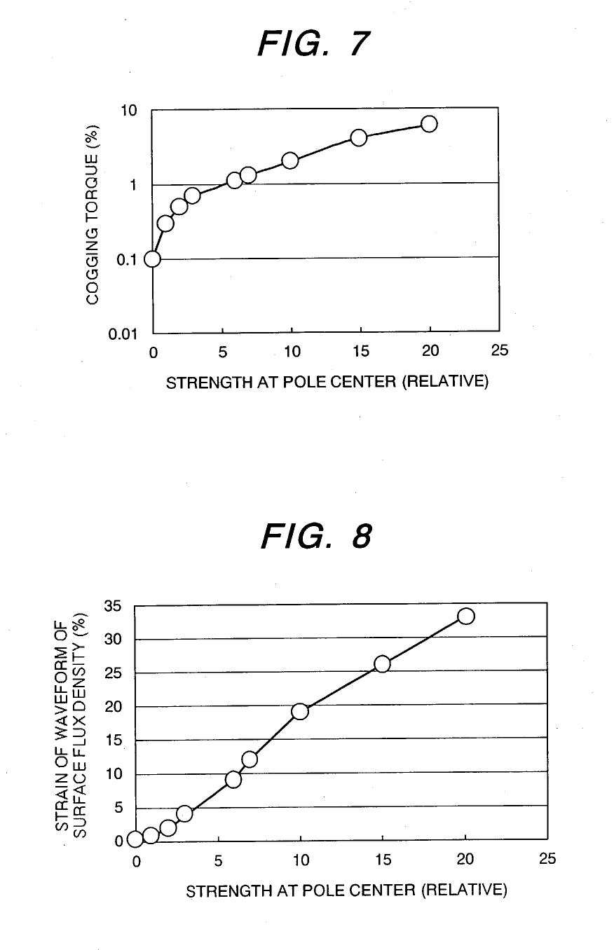

FIG. 7 is a diagrammatical drawing showing the relationship between cogging torque of a 10 poles ring magnet and X-ray diffraction strength, the X-ray diffraction strength representing a volume of magnetic powder whose c-axis is oriented in the circumferential direction.

As have been shown in FIGS. 3, 5, 6, current around the pole center position changes in accord with current flowing through the coils. It is better to decrease the volume of magnetic powder whose c-axis is oriented in the circumferential direction. If magnetic powder oriented in the circumferential direction at the pole center position increases, the cogging torque will increase.

In order to control cogging torque to 5% or less, the strength of c-axis oriented in the circumferential direction at the center of the poles should be 10 or less, and to control the cogging torque to be 1% or less, the strength of c-axis oriented in the circumferential direction at the pole center position should be 5 or less. This means that the volume of magnetic powder oriented in the circumferential direction at the pole center position is 5 or less based on 100 of the total volume of the magnetic powder. In other words, if the volume of magnetic powder that is oriented in the c-axis is controlled to about 5 or less (1/20 in the diametric direction), the cogging torque can be controlled to 5% or less.

FIG. 8 is a graph showing the relationship between surface magnetic flux density wave strain and X-ray diffraction strength of magnetic powder whose c-axis is oriented in the circumferential direction.

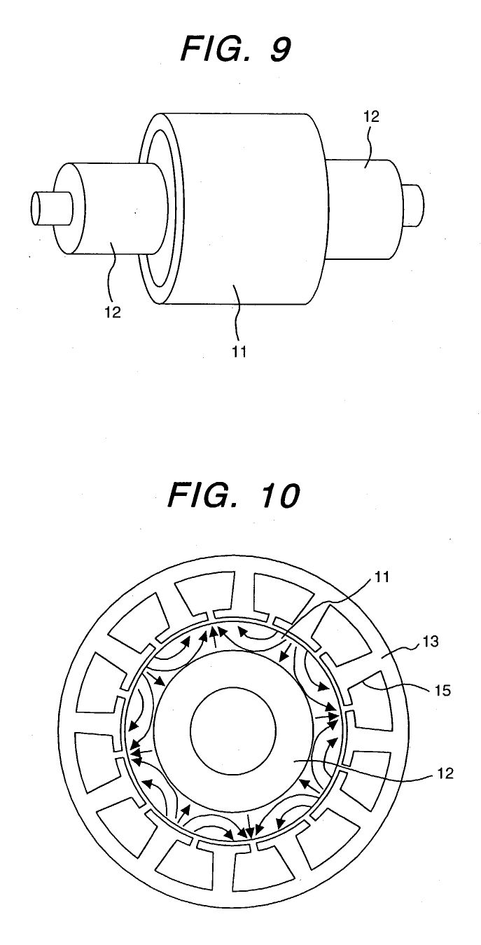

The surface magnetic flux density in the outer surface of the ring magnet was measured by a hall element in which the ring magnet was rotated. A structure used in this measurement is shown in FIG. 9.

The 10 poles ring magnet 11 was fixed to shaft 12, which was rotated with another motor to measure the surface magnetic flux density with a hall element. The distance between the hall element and the surface of the magnet was 0.1 to 0.2 micrometers.

The wave strain represents only components in which the basic wave component was removed from the whole waves of the surface flux density; and the ratio of the strain in the total wave is shown in FIG. 8. The larger the volume of the magnetic powder whose c-axis is oriented in the circumferential direction, the larger the wave form strain becomes. In order to achieve cogging torque of 5% or less, the strain should be controlled to be 10% or less.

FIG. 10 is a sectional view of a rotating machine using the rotor mentioned above. Shaft 12 is made of hard magnetic material or non-magnetic material such as carbon steel or stainless steel mentioned above. Ring magnets 1 were fixed with a resin adhesive to shaft 12.

Stator 13 has a core made of silicon steel plate having structure shown in FIG. 10. Coils (not shown) are wound on the yokes of the stator. A rotor is into the hollow of the stator to constitute the rotating machine.

The rotating machine of this example is particularly suitable for a positioning motor having a diameter of about 50 to 100 mm. This motor is suitable for AC servomotors for transferring and positioning silicon wafers, and head driving apparatus for hard disk driving devices.

The present invention provides motors with small cogging torque and high efficiency, and the motors ca suitably be used for industrial use, automotive use, transferring and positioning motors in the field of semiconductor devises, etc.

What is claimed is:

1. A ring magnet made of hard magnetic material having a ring shape, which has an orientation ratio of easy magnetization axis in the radial direction of the ring magnet being 50% by volume or more at the center between poles of the ring magnet.

2. A ring magnet made of hard magnetic material having a ring shape, which has an orientation ratio of easy magnetization axis in the radial direction of the ring magnet being 50% by volume or more at the center between poles of the ring magnet, wherein an orientation ratio of easy magnetization axis in the circumferential direction at the center between poles is 80% by volume or more.

3. A ring magnet made of hard magnetic material, which has an orientation ratio of easy magnetization axis in the vertical direction with respect to the radial direction at the center of the poles is 20% by volume or less.

4. A ring magnet made of hard magnetic material having an orientation ratio of easy magnetization axis at the center of the poles in the circumferential direction being 50% by volume or less, and having 10% or less of a wave strain of sin wave form of a magnetic flux density on an outer periphery surface of the ring magnet.

5. The ring magnet according to claim 1, wherein the number of the poles is 4 or more.

6. The ring magnet according to claim 1, wherein an angle where the orientation ratio is 50% by volume or more is within the range of 5 degrees.

7. A rotor using the ring magnet according to claim 1, wherein the magnet is fixed on the barrel of a shaft.

8. The rotor according to claim 7, the ring magnet is fixed by means of a resin adhesive or by metallurgical bonding.

9. The rotor according to claim 7, which has cogging torque of 5% or less.

10. A rotating machine comprising a stator, and a rotor that rotates in the stator, in which the rotor is one according to claim 7.

11. A positioning motor using the rotating machine according to claim 7.

12. A method of manufacturing a ring magnet comprising a step of Oriented magnetic powder of hard magnetic material, which comprises: molding the magnetic powder filled in a ring shaped mold under pressure in an axial direction of the ring, and applying magnetic field to the ring shaped mold with a magnetic field generating means disposed to the periphery of the mold, wherein the position of the magnetic field generating means is adjusted to produce a ratio of orientation of easy magnetization axis at the center between the adjoining poles is 50% by volume or more.

13. A method of manufacturing a ring magnet comprising a step of oriented magnetic powder of hard magnetic material, which comprises: molding the magnetic powder filled in a ring shaped mold under a pressure in an axial direction of the ring, and applying magnetic field to the ring shaped mold with a plurality of magnetic field generating means disposed to the periphery of the mold, wherein the magnetic field generating means are arranged at regular intervals around the mold, and wherein a first group of magnetic field generating means are disposed in a direction of the center between the poles at a radial direction of the ring magnet and a second group of magnetic field generating means are disposed in a circumferential direction of the ring magnet at the both sides of the first group of means.

14. A method of manufacturing a ring magnet comprising a step of oriented magnetic powder of hard magnetic material, which comprises: molding the magnetic powder filled in a ring shaped mold under a pressure in an axial direction of the ring, and applying magnetic field to the ring shaped mold with a plurality of magnetic field generating means disposed to the periphery of the mold, wherein the magnetic field generating means are arranged at regular intervals around the mold, and wherein a first group of magnetic field generating means are disposed in a direction of the center between the poles at a radial direction of the ring magnet and a second group of magnetic field generating means are disposed in a circumferential direction of the ring magnet at the both sides of the first group of means, and wherein a magnetic field strength in a radial direction is larger than that in the circumferential direction.

15. The method according to claim 12, wherein the adjoining magnetic field generating means generate alternately magnetic field of opposite directions.

16. The method according to claim 1, wherein the number of poles is 4 or more, and the magnetic field generating means opposite to each other generate magnetic field in the same direction.

17. The method according to claim 12, wherein a range of an angle, where the orientation ratio of the easy magnetization axis at the pole center position is 50% by volume or more is within a range of 5 degrees.

18. A method of a rotor having a ring magnet disposed on a periphery of a barrel, wherein the ring magnet is manufactured by the method according to claim 12.

19. The method according to claim 18, wherein the ring magnet is bonded to the barrel with a resin adhesive or with metallurgical bonding.

20. A magnetic filed generating apparatus for generating magnetic field by a plurality of magnetic field generating means disposed around a ring shaped metal mold, wherein the magnetic field generating means are arranged at regular intervals in accord with the number of poles, and wherein a first group of the magnetic field means are disposed at the center between the poles in a radial direction of the ring magnet, and a second group of the magnetic field generating means are disposed at the both ends of the first group of means in a circumferential direction.

21. A magnetic filed generating apparatus for generating magnetic field by a plurality of magnetic field generating means disposed around a ring shaped mold, wherein the magnetic field generating means are arranged at regular intervals in accord with the number of poles, and wherein a first group of the magnetic field means are disposed at the center between the poles in a radial direction of the ring magnet, and a second group of the magnetic field generating means are disposed at the both sides of the first group of means in a circumferential direction, and therein strength of magnetic field at the first group of means is larger than that of the second group of means.

22. The apparatus according to claim 20, wherein the adjoining magnetic field generating means alternately generate magnetic field of opposite direction.

23. The apparatus according to claim 20, wherein the number of the poles is 4 or more, and the magnetic field generating means opposite to each other generate the magnetic field in the same direction.

24. An apparatus for manufacturing a ring magnet comprising an apparatus for generating magnetic field generating apparatus disposed to the periphery of a ring shaped metal mold and means for molding by application of pressure in an axial direction of the mold, wherein the magnetic field generating apparatus is one defined in claim 20.
